(19) United States
(12) Patent Application Publication
(10) Pub. No.: US 2011/0164003 A1
(43) Pub. Date: Jul. 7, 2011

(54) IMAGE DISPLAY APPARATUS AND CONTROL METHOD FOR IMAGE DISPLAY APPARATUS

(75) Inventor: Koji Kobayashi, Yokohama-shi (JP)

(73) Assignee: CANON KABUSHIKI KAISHA, Tokyo (JP)

(21) Appl. No.: 12/981,055

(22) Filed: Dec. 29, 2010

(30) Foreign Application Priority Data
Jan. 6, 2010 (JP) 2010-001059

(51) Int. Cl. G09G 5/00

(52) U.S. Cl. 345/204; 345/55

(57) ABSTRACT

An image display apparatus includes: a display panel having at least a first region and a second region arranged in a scanning direction; a scanning circuit provided in common to the first region and the second region; a first modulation circuit provided for the first region; and a second modulation circuit provided for the second region, wherein a modulated signal applied by the first modulation circuit and a modulated signal applied by the second modulation circuit are pulse signals having a varying pulse height part and a fixed pulse height part, and the first modulation circuit and the second modulation circuit apply the modulated signals at timings ensuring that the fixed pulse height part of the modulated signal applied by the first modulation circuit does not temporally overlap the fixed pulse height part of the modulated signal applied by the second modulation circuit.

### BACKGROUND OF THE INVENTION

1. Field of the Invention

The present invention relates to an image display apparatus and a control method for an image display apparatus.

2. Description of the Related Art

In recent years, dramatic developments have occurred in the field of flat panel displays (FPD). FPDs include liquid crystal display apparatuses (LCD), plasma display apparatuses (PDP), electroluminescence display apparatuses (ELD) , and field emission display apparatuses (FED).

An FED in particular has a simple panel structure (a passive matrix structure) in which field emission elements are positioned at intersections between row wirings (scanning wirings) and column wirings (modulation wirings) , and is capable of high-speed response at low cost. Therefore, expectations are high for FEDs as next-generation displays.

In a display having a passive matrix structure, however, a display surface area is increased, leading to increases in line resistance and line-to-line capacitance, and as a result, an RC response time increases. This increase (delay) in the RC response time causes a delay in an operation of the display and a reduction in a luminance of the display.

As a method of solving this problem, a dual scanning system, in which a display region (a plurality of row wirings) of a display panel is divided into an upper side region and a lower side region and the row wirings of the respective regions are scanned in parallel may be employed. According to this method, a light emission time of the display can be increased, enabling an increase in the luminance and a reduction in the effects of line resistance and line-to-line capacitance. Note that in a display apparatus that can be driven using a dual scanning system, the column wirings are typically divided at a boundary between the upper side region and the lower side region, and therefore modulated signals are input independently into the column wirings in the upper side region and the column wirings in the lower side region.

When a moving image is displayed using the dual scanning system, a sense of discontinuity may occur in the displayed video, and therefore the following two methods have been proposed.

In the first method, a scanning direction of the row wirings is reversed between the upper side region and the lower side region (Japanese Patent Application Laid-open No. H05-143019). More specifically, scanning is performed from bottom to top in the upper side region and from top to bottom in the lower side region. Alternatively, scanning is performed from top to bottom in the upper side region and from bottom to top in the lower side region.

In the second method, the scanning direction of the row wirings is set to be identical in the upper side region and the lower side region, and a set of arranged wirings in the upper side region and a set of arranged wirings in the lower side region are driven by video signals (interpolated video signals) of frames shifted by half a period each from a vertical period of an input video signal (Japanese Patent Application Laid-open No. H10-268261, Japanese Patent Application Laid-open No. 2005-338491).

Furthermore, to reduce screen distortion when a moving image is displayed, a refresh rate may be set between 120 and 240 Hz by increasing a number of scans by a multiple of two to four rather than doubling a horizontal scanning period with the dual scanning system (Japanese Patent Application Laid-open No. 2005-338491).

### SUMMARY OF THE INVENTION

FIG. 2 shows a typical driving method (driving waveform) obtained when a display apparatus having a passive matrix structure is driven using the dual scanning system. In FIG. 2, a first row wiring (a first row wiring from the top of a screen) to an Mth row wiring (an Mth row wiring from the top of the screen) constitute the row wirings of the upper side region. An M+1th row wiring (an M+1th row wiring from the top of the screen) to a 2Mth row wiring (a 2Mth row wiring from the top of the screen) constitute the row wirings of the lower side region. Note that FIG. 2 shows an example of a case in which a pulse height of a modulated signal is modulated and an example of a case in which a single circuit (a scanning circuit) outputs two pulse signals simultaneously such that the row wirings of the upper side region and the lower side region are respectively scanned from top to bottom.

As shown in FIG. 2, in a typical driving method, pulse signals (scanning signals) having an identical pulse width are applied at an identical timing to the first row wiring and the M+1th row wiring, a second row wiring and an M+2th row wiring, . . . , and the Mth row wiring and the 2Mth row wiring, respectively. Further, pulse signals (modulated signals) having an identical pulse width are applied at an identical timing to the column wirings of the upper side region and the column wirings of the lower side region in synchronization with the scanning signals.

However, when an attempt is made to display an image such as that shown in FIG. 3B using this driving method, a display spot 42 is generated in a strip part 41 of the upper side region, as shown in FIG. 3F. Through committed research, the present inventor has discovered that this phenomenon occurs due to a mechanism such as the following. FIGS. 4, 5A, 5B, 6A, and 6B respectively show driving waveforms obtained when images shown in FIGS. 3A to 3E are displayed. Note that the driving waveform of the “upper screen Ath column wiring near Mth row” in FIGS. 4, 5A, 5B, 6A, and 6B denotes a waveform of a modulated signal input into an Ath column wiring (a modulation wiring of the upper side region in which the strip part 41 exists) in the vicinity of the Mth row wiring.

As shown in FIG. 4, substantially no noise appears on the waveforms of the scanning signals when an image such as that shown in FIG. 3A (an image not including a wide (long in a row direction) strip part 43) is displayed.

As shown in FIG. 5A, on the other hand, noise appears on the waveforms of the scanning signals when an image such as that shown in FIG. 3B (an image including the strip part 43) is displayed. More specifically, since the column wirings and the row wirings are capacitively coupled, the scanning signals (potentials) input into the row wirings of the lower side region fluctuate simultaneously at a rise timing and a fall timing of a modulated signal for displaying an image such as the strip part 43. This potential fluctuation propagates to a GND potential of the scanning circuit shared by the upper side region and the lower side region and to the scanning signals (the scanning signals input into the scanning wirings of the upper side region).

The potential fluctuation (noise) attenuates gradually while propagating and does not therefore propagate to all of the scanning signals input into the row wirings of the upper side region. Specifically, only the scanning signals input into the row wirings in the vicinity of the lower side region, from among the row wirings of the upper side region, are affected.

More specifically, when an image such as the strip part 43 is displayed in the lower side region at a timing where an upper side region row wiring in the vicinity of the lower side region is selected, as shown in FIGS. 3B and 3E, the display spot 42 is generated as follows, regardless of the scanning direction.

As shown in FIGS. 5A and 6B, first, noise in the lower side region propagates to the scanning signals input into the upper side region row wirings in the vicinity of the lower side region. Moreover, of this propagating noise, the noise that propagates to the scanning signals of unselected row wirings propagates to the modulated signals input into the column wirings of the upper side region (more specifically, values in the vicinity of the Mth row wiring fluctuate). As a result, the display spot 42 corresponding to the strip part 43 in the lower side region appears on a lower side of the strip part 41, as shown in FIGS. 3F and 3G, causing a reduction in display quality.

This noise is generated at the rise timing and fall timing of modulated signals for displaying a wide image. Therefore, if an SN ratio is raised by increasing a pulse width of the modulated signal sufficiently, the reduction in display quality can be reduced to an extent where it is undetectable by a human eye. However, when the refresh rate is set between 120 and 240 Hz in order to reduce distortion, the SN ratio decreases, and therefore a reduction in display quality is unavoidable. More specifically, in the case of a full HD (1920×1080 pixels) large-screen panel, an applied waveform is blunted by line resistance and line-to-line capacitance, and therefore approximately 1.5 μs are required for the pulse to rise and fall, respectively. As a result, an effective pulse width of the modulated signal becomes approximately 4 to 13 μs(≈μs/540×120 to 240)−1.5×2 μs), and therefore the SN ratio decreases. This tendency becomes steadily more striking with increases in definition.

Although a case in which the pulse height of the modulated signal is modulated (a pulse amplitude modulation system) was described above, a similar phenomenon occurs when the pulse width is modulated (a pulse width modulation system). In a pulse amplitude modulation system, the rise and fall timings remain constant at all times, regardless of a gradation, despite the comparatively large pulse width, and accordingly the comparatively large signal level, of the modulated signal, and therefore noise timings (a phase) are aligned, leading to an increase in a noise level. In a pulse width modulation system, on the other hand, the fall timing of the modulated signal varies according to the gradation, and therefore the noise timings (phase) are dispersed, leading to a reduction in the noise level. On a low gradation side, however, the pulse width is small and therefore the signal level decreases, leading to a reduction in the SN ratio. With both systems (the pulse amplitude modulation system and the pulse width modulation system), when a display apparatus is driven using a conventional dual scanning system, a reduction in display quality caused by a reduction in the SN ratio is unavoidable. Even when the pulse height and the pulse width are both modulated, a similar phenomenon occurs for the above reasons.

The above phenomenon can be eliminated by scanning the row wirings of the upper side region and the lower side region respectively using two independent scanning circuits (an upper side region scanning circuit and a lower side region scanning circuit). In this case, however, if the scanning signals applied to the row wirings of the upper side region and the lower side region are even slightly different (if characteristics of the two scanning circuits are even slightly different), a boundary line between the upper side region and the lower side region appears on the image, and therefore the display quality deteriorates even further.

Methods of reducing noise-induced luminance variation by measuring a number of lit (driven) pixels on a single line, gradation levels thereof, or the like and using the resulting measurement values to correct the video signal and the modulated signal have also been considered. However, the phenomenon described above occurs not only on a single line but also through interaction between two simultaneously selected lines. Moreover, this is a complex phenomenon whereby a magnitude of the interaction varies in accordance with a distance (number of rows) from the boundary between the upper side region and the lower side region to the selected lines. It is therefore difficult to perform calculations required for the correction, and as a result, an increase in circuit scale occurs. Hence, this type of correction is not realistic in terms of calculation speed, heat generation, and cost.

The present invention provides a technique with which a reduction in image quality occurring when an image display apparatus is driven using a dual scanning system can be reduced through a simple constitution.

The present invention in its first aspect provides an image display apparatus comprising:

a display panel which has at least a first region and a second region arranged in a scanning direction, and on which a plurality of scanning wirings and a plurality of modulation wirings disposed in a matrix shape and a plurality of display elements connected to the plurality of scanning wirings and the plurality of modulation wirings are provided respectively in the first region and the second region;

a scanning circuit that is provided in common to the first region and the second region and scans the scanning wirings in each of the regions such that at least a part of a period for scanning the scanning wirings in the first region overlaps at least a part of a period for scanning the scanning wirings in the second region;

a first modulation circuit provided for the first region to apply a modulated signal to the plurality of modulation wirings in the first region; and

a second modulation circuit provided for the second region to apply a modulated signal to the plurality of modulation wirings in the second region,

wherein the modulated signal applied by the first modulation circuit and the modulated signal applied by the second modulation circuit are pulse signals having a varying pulse height part and a fixed pulse height part, and

the first modulation circuit and the second modulation circuit apply the modulated signals at timings ensuring that the fixed pulse height part of the modulated signal applied by the first modulation circuit does not temporally overlap the fixed pulse height part of the modulated signal applied by the second modulation circuit.

The present invention in its second aspect provides an image display apparatus comprising:

a display panel which has at least a first region and a second region arranged in a scanning direction, and on which a plurality of scanning wirings and a plurality of modulation wirings disposed in a matrix shape and a plurality of display elements connected to the plurality of scanning wirings and the plurality of modulation wirings are provided respectively in the first region and the second region;

a scanning circuit that is provided in common to the first region and the second region and scans the scanning wirings in each of the regions such that at least a part of a period for scanning the scanning wirings in the first region overlaps at least a part of a period for scanning the scanning wirings in the second region;

a first modulation circuit provided for the first region to apply a modulated signal to the plurality of modulation wirings in the first region; and

a second modulation circuit provided for the second region to apply a modulated signal to the plurality of modulation wirings in the second region,

wherein the modulated signal applied by the first modulation circuit and the modulated signal applied by the second modulation circuit are pulse signals in which either a pulse width or both the pulse width and a pulse height have been modulated, and

the first modulation circuit and the second modulation circuit apply the modulated signals at timings ensuring that the modulated signal applied by the first modulation circuit and the modulated signal applied by the second modulation circuit rise at different times.

According to the present invention, a reduction in image quality occurring when an image display apparatus is driven using a dual scanning system can be reduced through a simple constitution.

Further features of the present invention will become apparent from the following description of exemplary embodiments with reference to the attached drawings.

### BRIEF DESCRIPTION OF THE DRAWINGS

FIG. 1A is a view showing an example of the constitution of an image display apparatus according to the present embodiment;

FIG. 1B is a view showing an example of an electron emission characteristic;

FIG. 2 is a view showing an example of conventional driving waveforms;

FIGS. 3A to 3G are views showing examples of displayed images;

FIG. 4 is a view showing conventional driving waveforms and noise propagation;

FIGS. 5A and 5B are views showing conventional driving waveforms and noise propagation;

FIGS. 6A and 6B are views showing conventional driving waveforms and noise propagation;

FIG. 7 is a view showing conventional modulated signal application timings;

FIG. 8A is a view showing an example of modulated signal application timings according to a first example;

FIG. 8B is a view showing an example of modulated signal application timings according to a second example;

FIGS. 9A and 9B are views showing examples of modulated signal application timings according to a third example;

FIG. 10 is a view showing an example of modulated signal application timings according to a fourth example;

FIGS. 11A and 11B are views showing examples of modulated signal application timings according to a fifth example;

FIGS. 12A to 12C are views showing examples of modulated signal application timings according to the present embodiment; and

FIGS. 13A to 13D are views showing examples of blank periods between modulated signals.

### DESCRIPTION OF THE EMBODIMENTS

### Overall Constitution

An image display apparatus and a control method thereof according to the present embodiment will be described below. According to the present invention, a reduction in image quality occurring when an image display apparatus is driven using a dual scanning system can be reduced effectively. A specific example in which the present invention is applied to an image display apparatus having field emission elements (electron-emitting devices) as display elements will be described below, but the display element is not limited to this type and may be a plasma element, a liquid crystal element, an EL element, and so on, for example. Note, however, that the luminance of EL elements and electron-emitting devices varies exponentially relative to a voltage, and therefore voltage variation occurring when an image display apparatus is driven using a dual scanning system appears strikingly on an image (the image quality deteriorates greatly). Hence, the present invention can be applied particularly favorably to an image display apparatus having this type of display element.

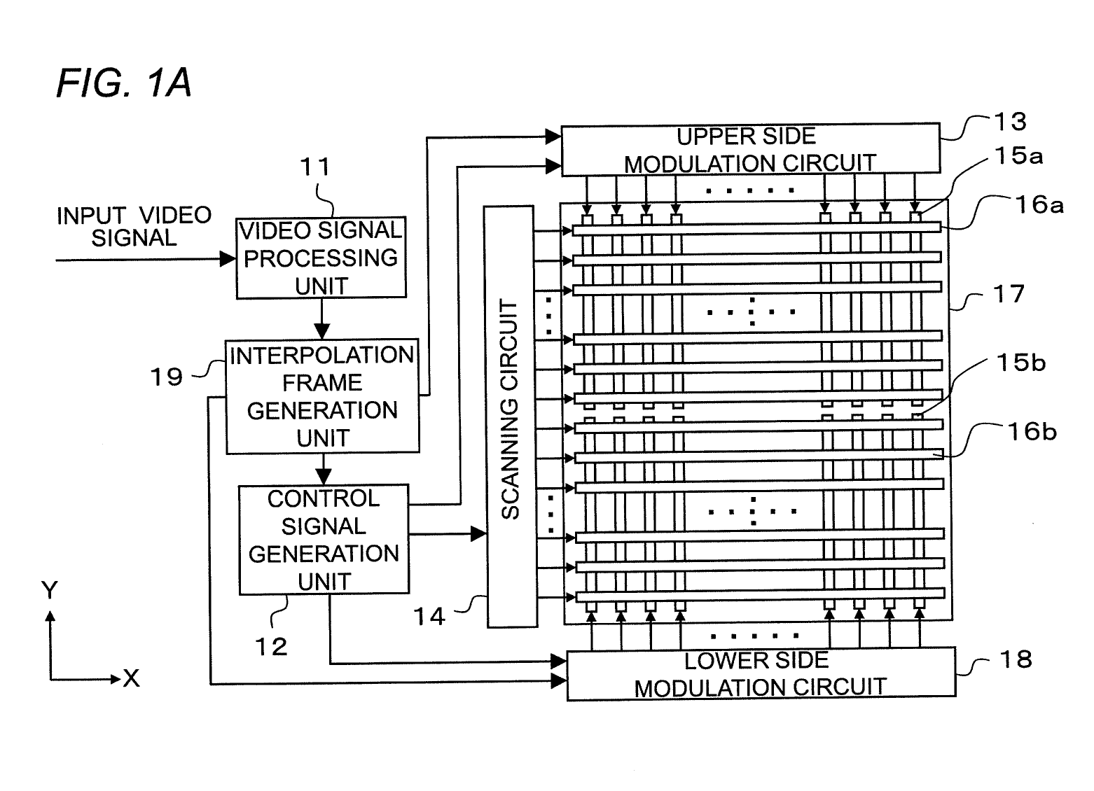

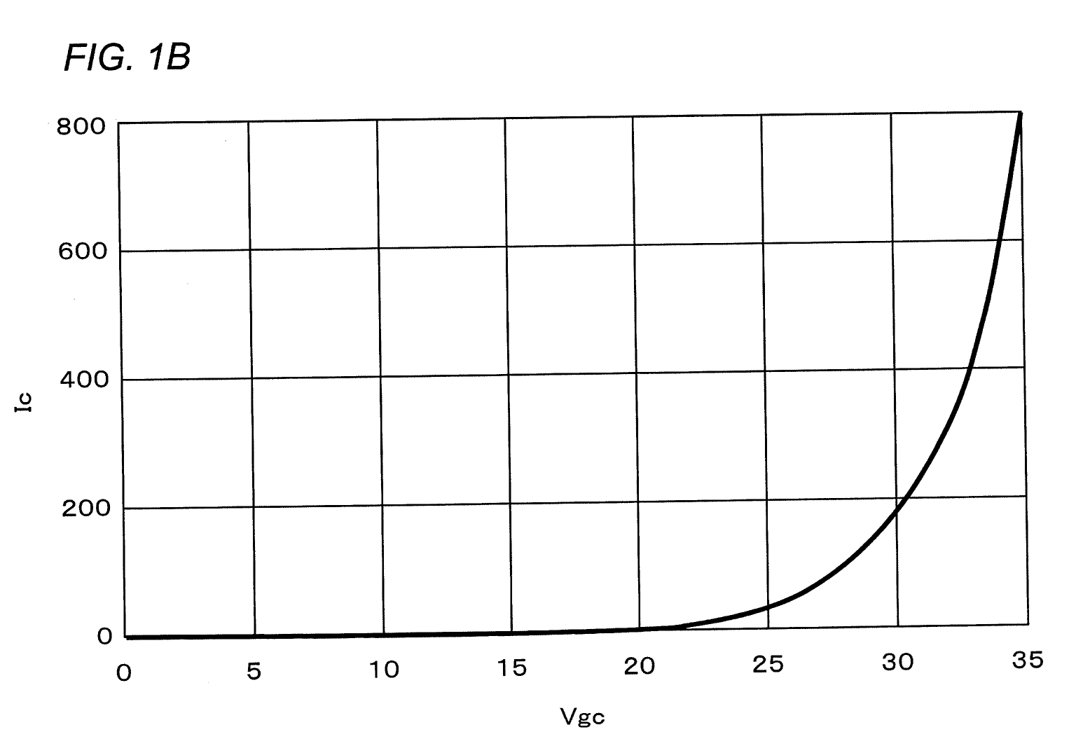

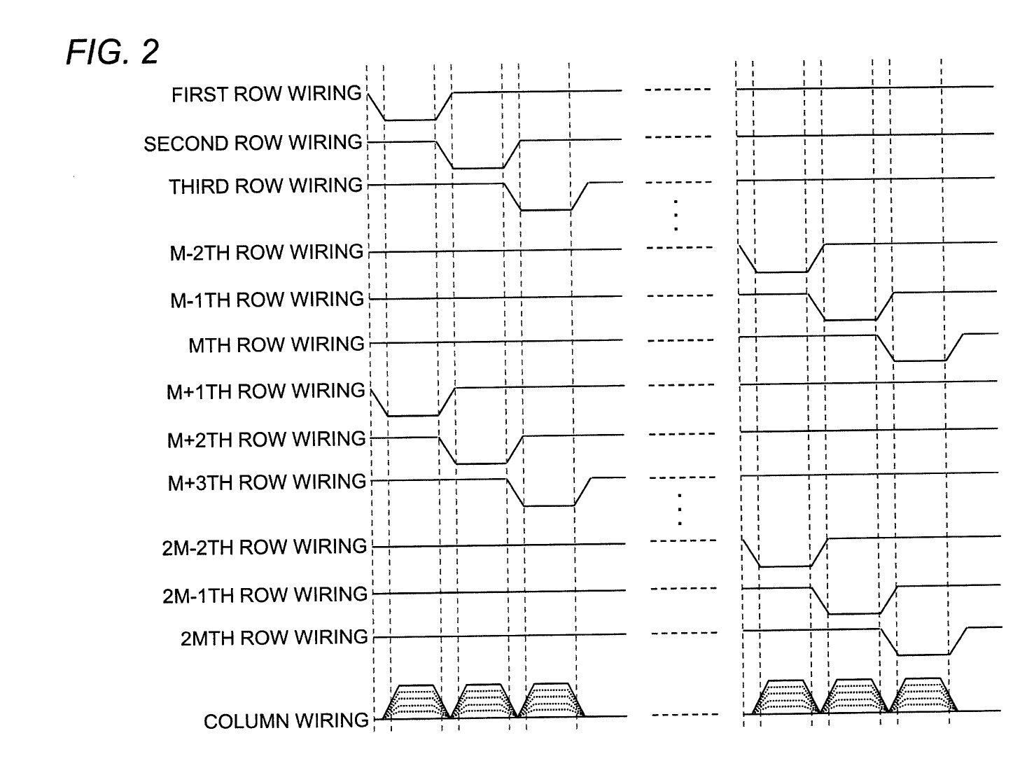

FIG. 1A is a view showing an example of the image display apparatus according to this embodiment.

A back surface substrate 17 is a glass substrate constituting a cathode panel. The back surface substrate 17 includes at least a first region and a second region arranged in a scanning direction. A plurality of scanning wirings (row wirings) and a plurality of modulation wirings (column wirings) disposed in a matrix shape are provided respectively in the first region and the second region on the back surface substrate 17. Further, a plurality of display elements (electron-emitting devices) connected to the plurality of row wirings and the plurality of column wirings are provided on the back surface substrate 17. More specifically, a display element (electron-emitting device) is disposed on each intersection between the plurality of row wirings and the plurality of column wirings, and the display elements in the respective regions are driven independently. Note that in this embodiment, a case in which the back surface substrate 17 includes two regions, namely an upper side region (the first region) and a lower side region (the second region) formed on either side of a screen center, (i.e. a case in which the modulation wirings are divided into an upper side and a lower side about the screen center) will be described. An anode panel (a front surface substrate) including a phosphor that emits light when electrons emitted from the electron-emitting devices collide is disposed above and opposite the cathode panel and forms a display panel together with the back surface substrate 17.

Further, the image display apparatus according to this embodiment includes a scanning circuit 14 provided in common to the first region and the second region (the upper side region and the lower side region). An upper side modulation circuit 13 (a first modulation circuit) is provided for the upper side region, and a lower side modulation circuit 18 (a second modulation circuit) is provided for the lower side region. The row wirings (upper side row wirings 16a) of the upper side region and the row wirings (lower side row wirings 16b) of the lower side region are connected to the scanning circuit 14. The column wirings (upper side column wirings 15a) of the upper side region are connected to the upper side modulation circuit 13, and the column wirings (lower side column wirings 15b) of the lower side region are connected to the lower side modulation circuit 18.

The image display apparatus according to this embodiment further includes a video signal processing unit 11, an interpolation frame generation unit 19, and a control signal generation unit 12. Note that in this embodiment, a case in which a digital signal is input as an input video signal will be described, but the input video signal may be an analog signal. The input video signal is input into the video signal processing unit 11. The interpolation frame generation unit 19 generates an intermediate frame (an intermediate image) that is interpolated between frames of the input video signal in order to increase a refresh rate. The control signal generation unit 12 controls a drive circuit in accordance with image data (generates control signals for generating modulated signals and scanning signals, as will be described below).

Respective functions of the image display apparatus according to this embodiment will now be described in detail.

The scanning circuit 14 is capable of selecting a plurality of row wirings simultaneously. In this embodiment, the upper side row wirings 16a and the lower side row wirings 16b are scanned in parallel. More specifically, the scanning wirings of the respective regions are scanned such that at least a part of a scanning period of the upper side row wirings 16a and at least a part of a scanning period of the lower side row wirings 16b overlap. Here, the term “scan” denotes processing for selecting the row wirings successively one line at a time. For example, a voltage of −20 V is applied to a row wiring when selected, and a voltage of 7 V is applied to the row wiring when not selected (selection voltage; scanning signal). Further, in this embodiment, the scanning circuit 14 is shared by the upper side region and the lower side region (more specifically, a power supply and a GND potential are shared by the regions), and therefore generation of a boundary line caused by a deviation in the selection voltage on a boundary between the upper side region and the lower side region is suppressed.

The upper side modulation circuit 13 and the lower side modulation circuit 18 apply modulated signals to the plurality of column wirings in their respective corresponding regions. More specifically, the upper side modulation circuit 13 applies a modulated signal (an upper side modulated signal) to the plurality of upper side column wirings 15a, and the lower side modulation circuit 18 applies a modulated signal (a lower side modulated signal) to the plurality of lower side column wirings 15b. The upper side modulation circuit 13 and the lower side modulation circuit 18 are respectively constituted by a shift register, a line memory, a modulated signal generation unit, and so on, not shown in the drawing. An input video signal (for example, R (red), G (green), B (blue) digital signals) corresponding to a single line (=a single horizontal scanning period) is input into the shift register. The line memory retains the input video signal for the single line. The modulated signal generation unit applies a modulated signal Vx to each column wiring in accordance with the input video signal for the single line retained in the line memory. The upper side modulated signal and the lower side modulated signal are pulse signals having a part in which a pulse height varies (a varying part) and a part in which the pulse height is fixed (a steady part).

A method of driving the display elements (electron-emitting devices) will now be described. Note that for simplicity, only one region will be described below. Further, it is assumed that the electron-emitting devices have an electron emission characteristic such as that shown in FIG. 1B. In FIG. 1B, the ordinate shows an amount of electrons (an electron amount Ic) emitted from the electron-emitting device, and the abscissa shows a differential voltage between the scanning signal and the modulated signal (a differential voltage Vgc between a gate electrode and a cathode electrode of the electron-emitting device).

When a 15 V modulated signal is applied to a column wiring, the differential voltage Vgc of the electron-emitting devices connected to the selected row wirings (in other words, the row wirings to which the −20 V scanning signal is applied) reaches 35 V, and therefore the electron amount Ic of these electron-emitting devices takes a large value. As a result, a large number of electrons collide with the phosphor such that high-luminance light is emitted. At this time, the differential voltage Vgc of the display elements connected to the unselected row wirings (in other words, the row wirings to which the 7 V scanning signal is applied) is 8 V, and therefore no electrons are emitted from these display elements (light emission does not occur).

Further, when a 0 V modulated signal is applied to a column wiring, no electrons are emitted from the electron-emitting devices regardless of the selection state of the connected row wirings. More specifically, the differential voltage Vgc of the electron-emitting devices connected to the selected row wirings is 20 V, and therefore no electrons are emitted. Meanwhile, the differential voltage Vgc of the electron-emitting devices connected to the unselected row wirings is 7V, and therefore no electrons are emitted.

By controlling the pulse height of the modulated signal in accordance with the input video signal in this manner, the amount of electrons emitted from the electron-emitting devices can be controlled (no electrons are emitted from the electron-emitting devices connected to the unselected row wirings). In other words, by controlling the pulse height of the modulated signal, the phosphor corresponding to the electron-emitting devices connected to the selected row wirings can be caused to emit light at a desired luminance. Note that a desired gradation can be expressed likewise by modulating the pulse width or both the pulse width and the pulse height (higher luminance light can be emitted as the pulse width is increased). In the image display apparatus according to this embodiment, the modulated signal is applied to a plurality of column wirings (column wirings corresponding to one line of an image) in synchronization with row wiring selection, and as a result, an image corresponding to a single line is displayed.

The video signal processing unit 11 implements image quality adjustment processing and matrix processing on the input video signal, outputs R, G, B (eight bits each) digital signals, and al so outputs a horizontal synchronizing signal and a vertical synchronizing signal. The R, G, B digital signals, horizontal synchronizing signal, and vertical synchronizing signal are input into the interpolation frame generation unit 19.

The interpolation frame generation unit 19 increases the refresh rate of the input video signal by generating an interpolation frame that is interpolated between two consecutive frames of the input video signal. For example, a single interpolation frame is inserted between frames of a 60 frames/sec input video signal to generate a 120 frames/sec video signal. Note that two interpolation frames may be inserted between frames of the input video signal so that a 240 frames/sec video signal is generated (the number of interpolation frames and the value of the refresh rate may be set as desired).

The interpolation frame generation unit 19 then divides the generated video signal into the regions. More specifically, the generated video signal is divided into a video signal (an upper side video signal) to be displayed in the upper side region and a video signal (a lower side video signal) to be displayed in the lower side region, whereupon an upper side video is output to the upper side modulation circuit 13 and a lower side video is output to the lower side modulation circuit 18. The upper side video signal and lower side video signal are 24-bit R, G, B (eight bits each) parallel input digital signals, for example, and although not shown in the drawing, a single pixel is sampled by a reference dot clock for reproducing a digital video signal.

Further, the interpolation frame generation unit 19 outputs the horizontal synchronizing signal and the vertical synchronizing signal to the control signal generation unit 12.

The control signal generation unit 12 generates a control signal on the basis of the horizontal synchronizing signal and vertical synchronizing signal. More specifically, the control signal generation unit 12 generates an upper side video intake start pulse and a lower side video intake start pulse indicating video intake start timings of the upper side modulation circuit 13 and the lower side modulation circuit 18. Further, the control signal generation unit 12 generates an upper side modulated signal generation pulse and a lower side modulated signal generation pulse indicating modulated signal generation timings of the upper side modulation circuit 13 and the lower side modulation circuit 18. Furthermore, the control signal generation unit 12 generates a scanning signal generation pulse indicating a scanning signal generation timing of the scanning circuit 14 and a row wiring selection shift clock serving as a reference shift clock for scanning the scanning wirings. Note that the scanning signal generation pulse and the row wiring selection shift clock may be constituted by information that is shared by the upper side region and the lower side region or information that is provided to each region individually. In other words, the scanning wirings of the upper side region and the lower side region may be selected simultaneously or at different timings.

The upper side modulation circuit 13 detects the upper side video intake start pulse immediately before the upper side video signal is input (at an immediately previous clock of the dot clock, for example). The upper side video signal is then taken into the shift register successively in line units in synchronization with the dot clock. Once the upper side video signal for a single line has been taken in, the upper side modulation circuit 13 detects the upper side modulated signal generation pulse and synchronously therewith transmits the upper side video signal for the single line to the line memory. Single-line video data transmitted to the line memory are then subjected to D/A conversion and the like simultaneously in pixel units, and then output as a modulated signal constituted by an analog voltage.

The lower side modulation circuit 18 detects the lower side video intake start pulse, the lower side modulated signal generation pulse, and so on, and outputs a modulated signal in a similar manner to the upper side modulation circuit 13.

The scanning circuit 14 selects a row wiring using the scanning signal generation pulse as a reference, and scans the row wiring in synchronization with the wiring selection shift clock.

### Related Art

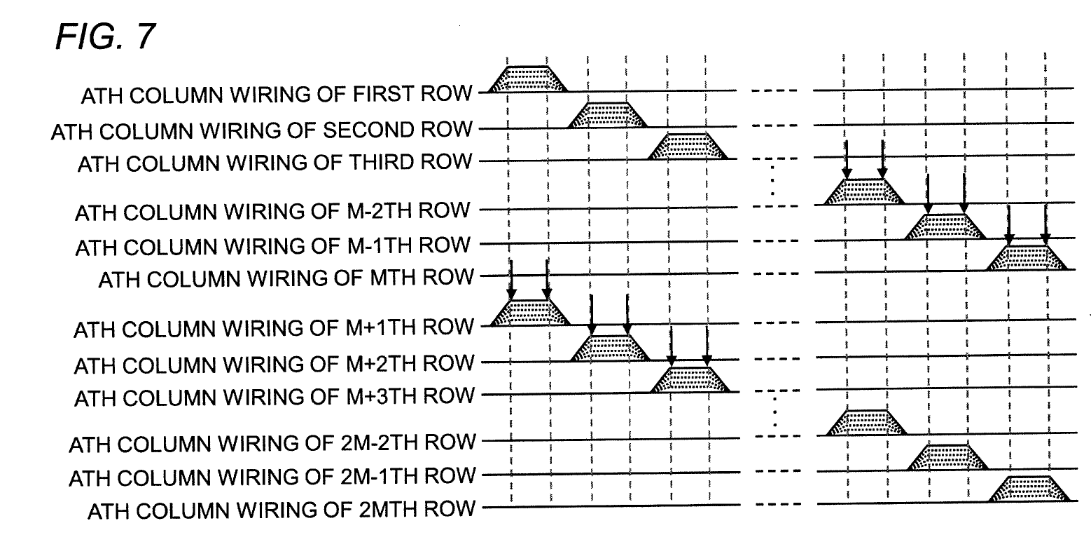

FIG. 7 shows an example of a conventional driving method (modulated signal application timing). Note that a first row wiring (a first row wiring from the top of a screen) to an Mth row wiring (an Mth row wiring from the top of the screen) constitute the row wirings of the upper side region, while an M+1th row wiring (an M+1th row wiring from the top of the screen) to a 2Mth row wiring (a 2Mth row wiring from the top of the screen) constitute the row wirings of the lower side region. Further, FIG. 7 shows an example in which the row wirings of the upper side region and the row wirings of the lower side region are respectively scanned from top to bottom. The driving waveform of the “Ath column wiring of Xth row” (where X is an integer between 1 and 2 M) in the drawing denotes the waveform of a modulated signal that is applied to the Ath column wiring synchronously with selection of the Xth row wiring.

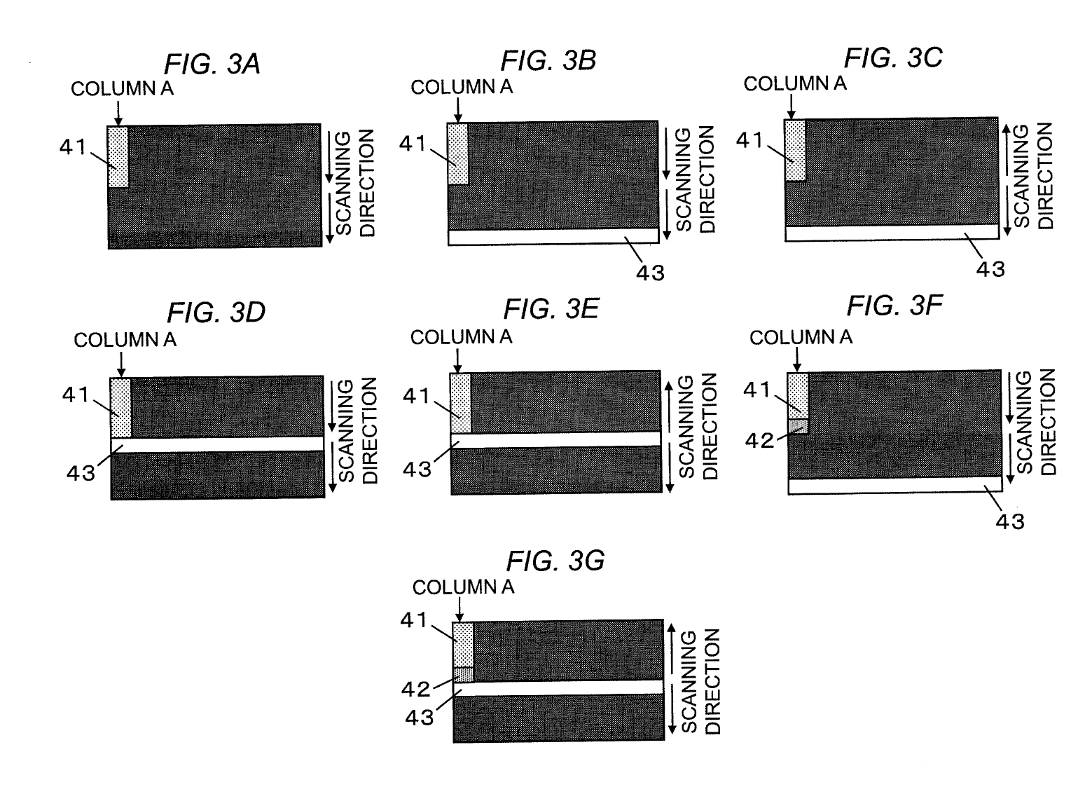

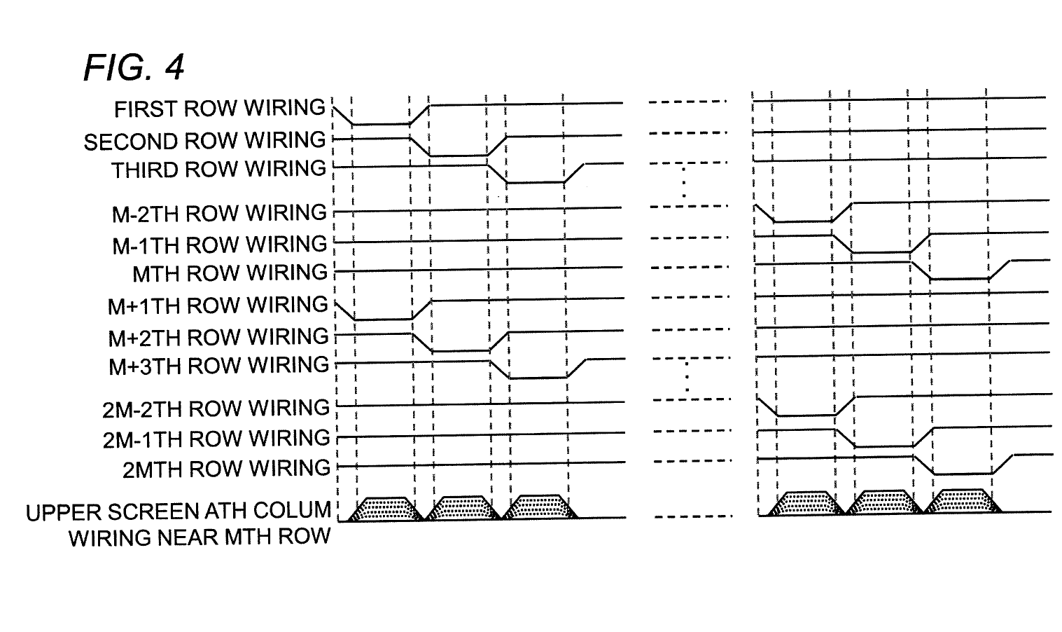

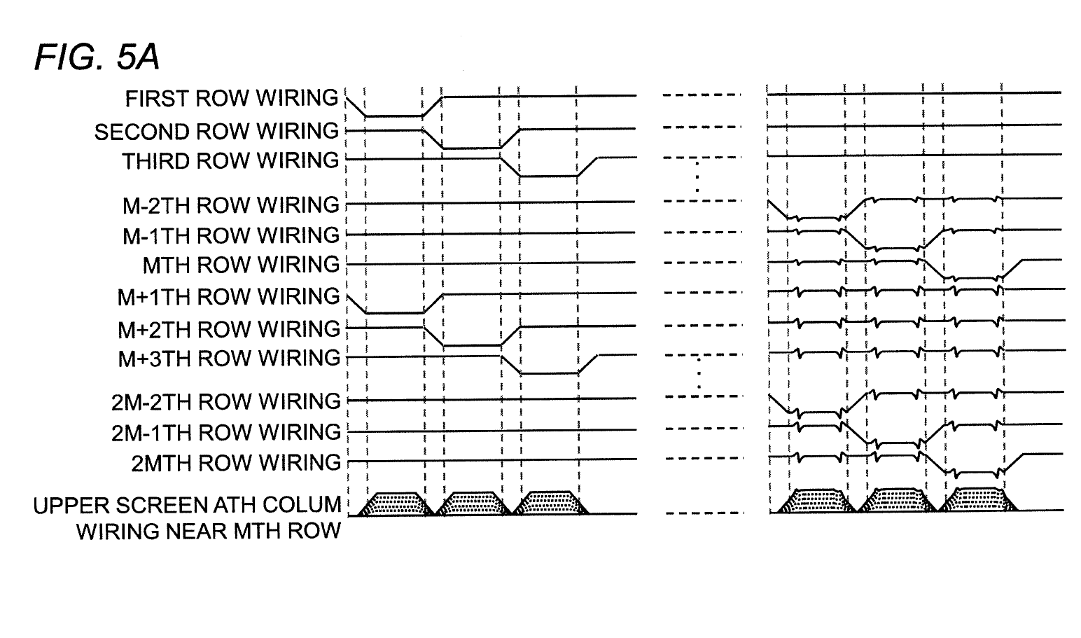

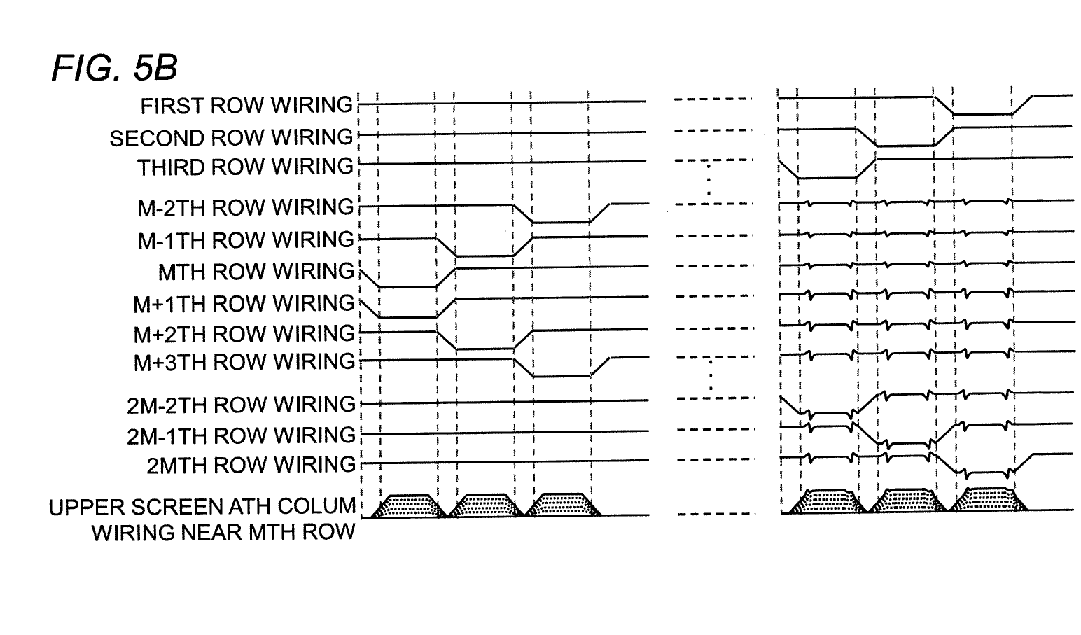

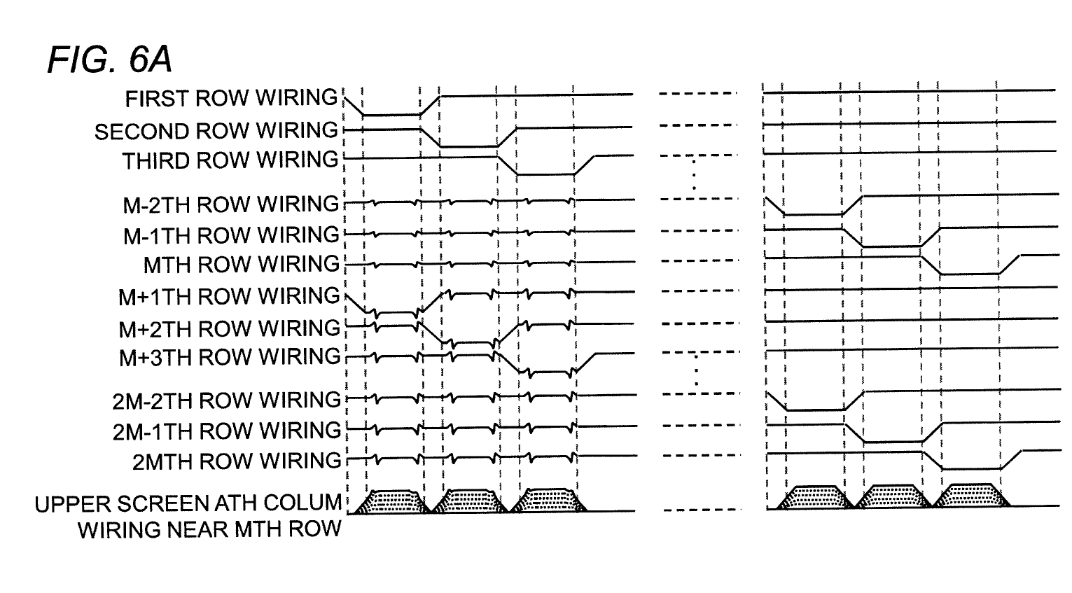

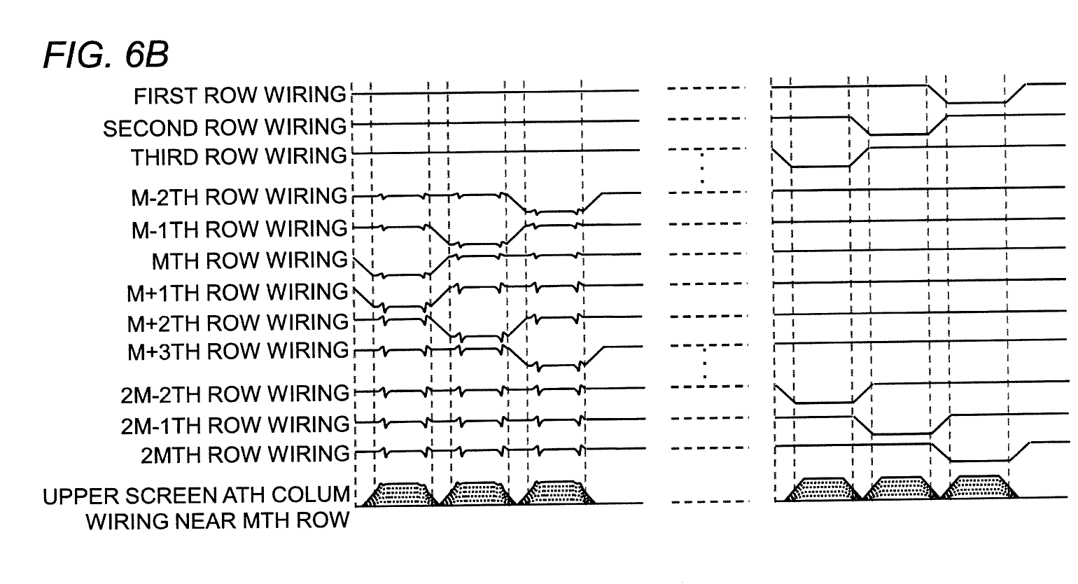

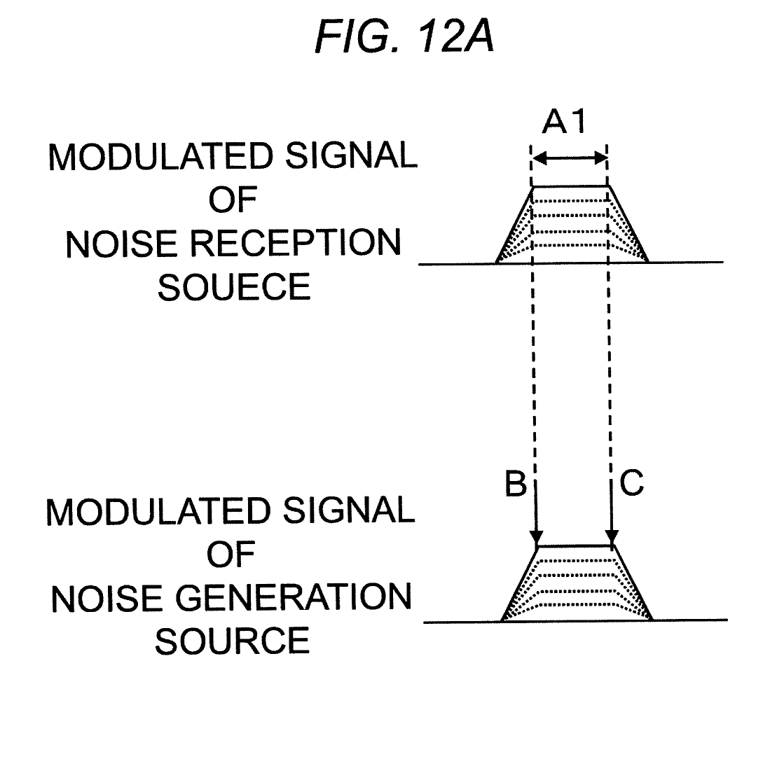

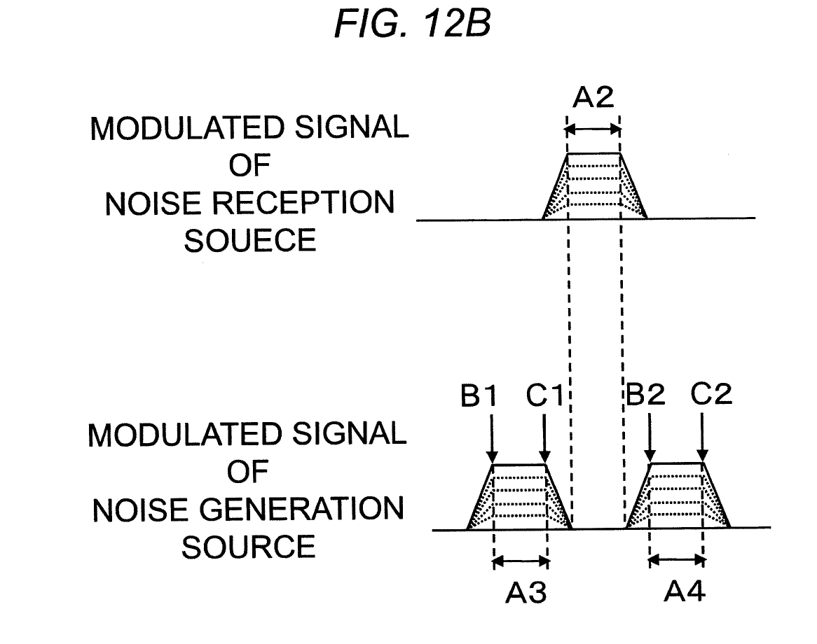

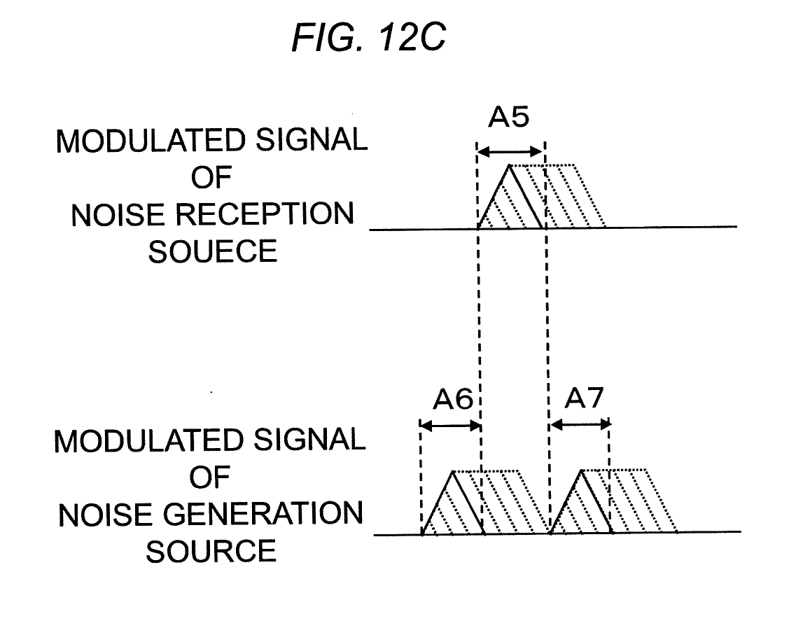

As shown in FIG. 7, in a conventional method, the modulated signal application timings are aligned in the upper side region and the lower side region. Therefore, as shown in FIG. 12A, timings B, C at which noise (potential fluctuation) is generated in one modulated signal (a noise generation source) overlap a steady part (a period A1 in which the effect of noise on the luminance of the emitted light is large) of another modulated signal (a noise reception source). As a result, a reduction in display quality (a reduction in image quality) is caused by noise propagation. Further, the noise gradually attenuates while propagating, and therefore the noise propagates to a position indicated by an arrow in FIG. 7, for example. Hence, when an attempt is made to display an image such as that shown in FIG. 3B, a display spot 42 such as that shown in FIG. 3F appears.

Note that FIGS. 7 and 12A show an example in which the pulse height of the modulated signal is modulated (a pulse amplitude modulation system), but a similar phenomenon occurs when the pulse width is modulated (a pulse width modulation system). A similar phenomenon also occurs when the pulse width and the pulse height are both modulated.

### Driving Method According to this Embodiment

A driving method (modulated signal application timing) according to this embodiment will now be described.

### First Example

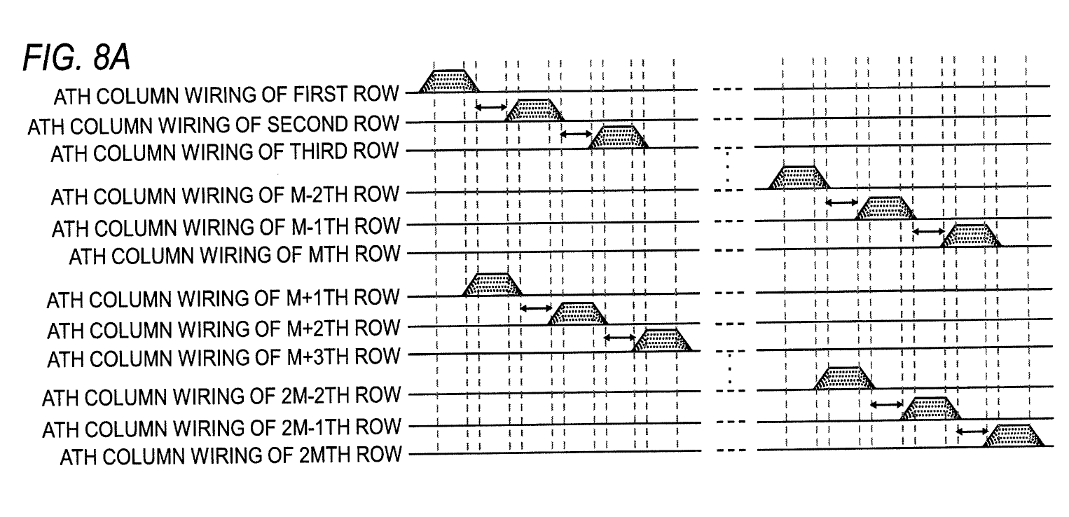

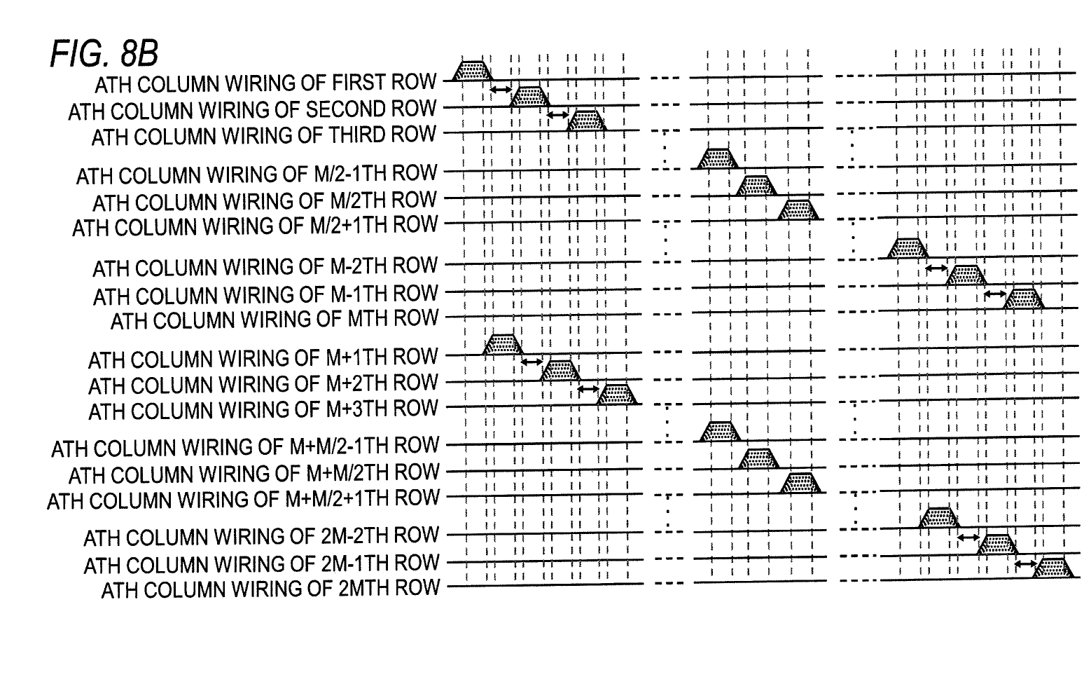

In a first example, as shown in FIGS. 8A and 12B, the upper side modulation circuit 13 and lower side modulation circuit 18 apply the modulated signals at timings ensuring that the steady part of the upper side modulated signal and the steady part of the lower side modulated signal do not temporally overlap. In other words, the modulated signals are applied at timings ensuring that a period A2 does not temporally overlap periods A3, A4 in FIG. 12B.

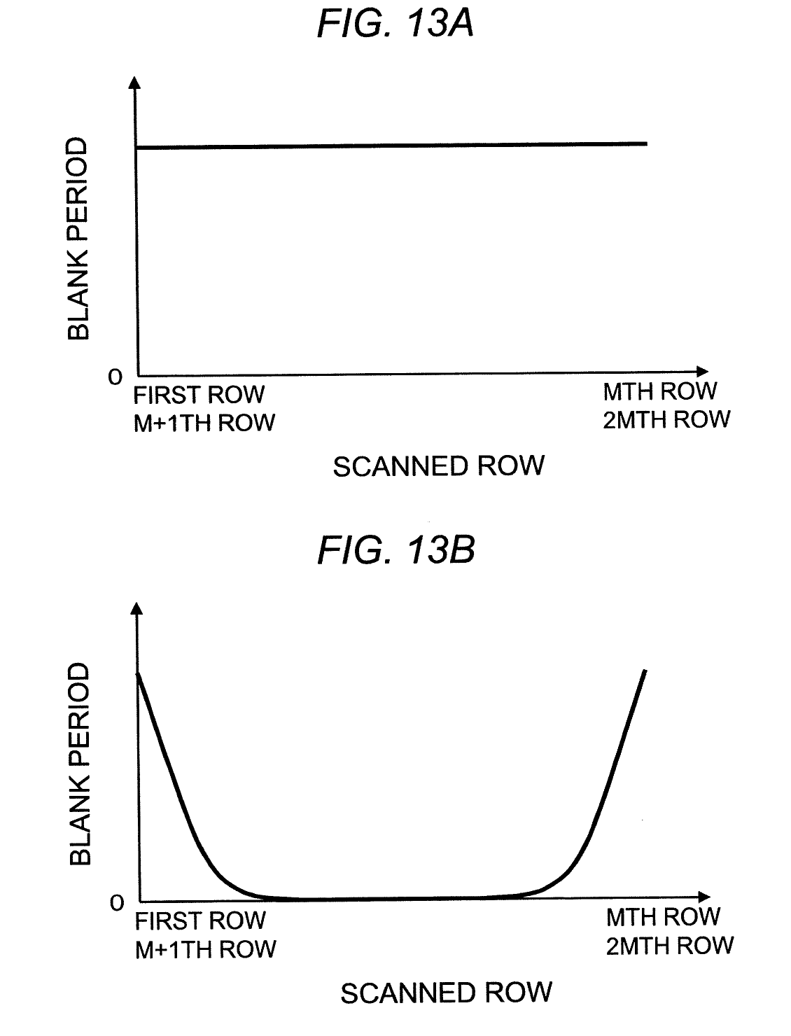

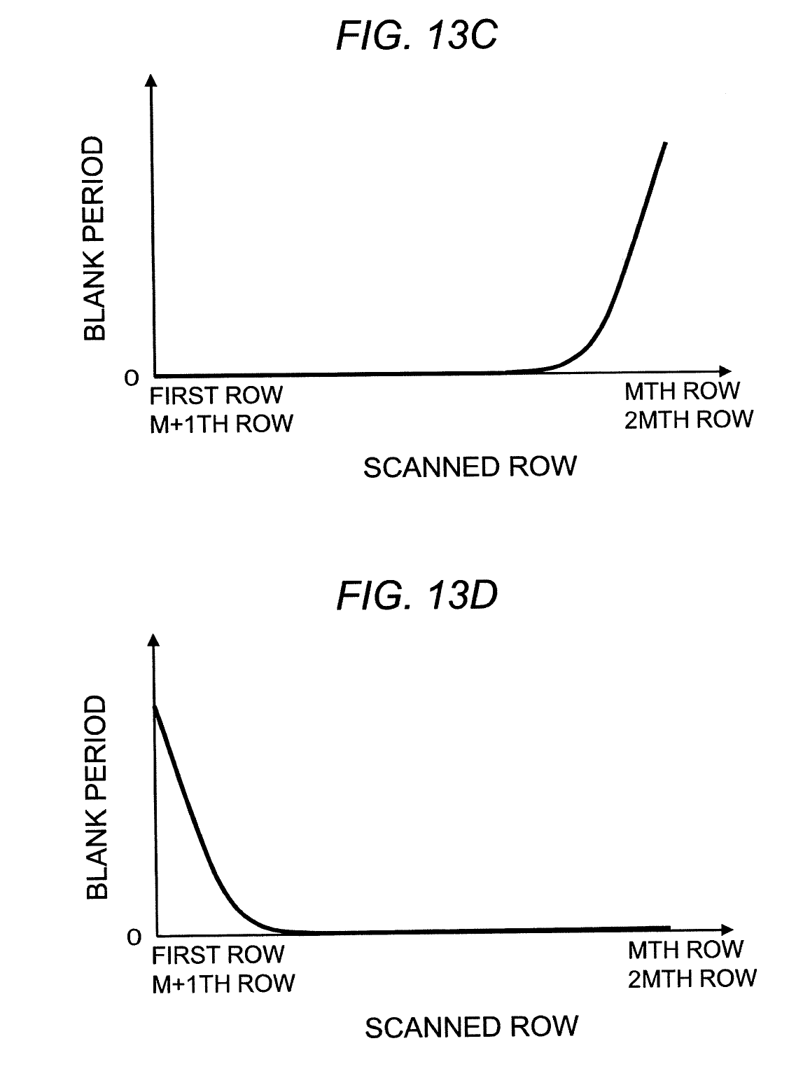

For example, as shown in FIG. 13A, the upper side modulation circuit 13 and the lower side modulation circuit 18 provide a fixed blank period (corresponding to the period A2 in FIG. 12B) between a modulated signal applied synchronously with selection of a certain row wiring and a modulated signal applied synchronously with selection of the next row wiring. The modulated signals are then applied at timings ensuring that the steady part of one modulated signal exists in the blank period of the other modulated signal. Here, the term “blank period” denotes a period during which a modulated signal is not applied.

As shown in FIG. 12B, with this constitution, timings B1, B2, C1, C2 at which noise is generated in the modulated signal, which is the noise generation source, deviate from the steady part (the period A2) of the modulated signal, which is the noise reception source. As a result, a reduction in display quality caused by propagating noise can be suppressed.

Note that FIGS. 8A and 12B show an example of the pulse amplitude modulation system, but the first example may also be applied to the pulse width modulation system or a system in which both the pulse width and the pulse height are modulated.

In the first example, the scanning direction of the scanning wirings in the upper side region is identical to the scanning direction of the scanning wirings in the lower side region, but the scanning directions are not limited thereto, and the scanning wirings of the upper side region may be scanned in an opposite direction to the scanning wirings of the lower side region.

### Second Example

In the first example, the fixed blank period is provided between a modulated signal applied synchronously with selection of a certain row wiring and a modulated signal applied synchronously with selection of the next row wiring. As a result, a driving time loss occurs such that when an attempt is made to maintain the refresh rate, the pulse width of the modulated signal decreases, leading to a reduction in a maximum luminance.

Hence, in a second example, the upper side modulation circuit 13 and the lower side modulation circuit 18 provide the blank period between modulated signals only during a period in which a row wiring (a row wiring near the boundary) positioned within a predetermined range from the boundary between the upper side region and the lower side region has been selected by the scanning circuit 14. More specifically, as shown in FIGS. 8B and 13B, the upper side modulation circuit 13 and the lower side modulation circuit 18 apply the modulated signals at timings ensuring that the steady part of the upper side modulated signal and the steady part of the lower side modulated signal do not temporally overlap only during a steady period of modulated signals from an M−2th row to an M+3th row.

A reduction in display quality caused by propagating noise occurs near the boundary between the upper side region and the lower side region. Therefore, a reduction in display quality caused by propagating noise can be suppressed in the second example for similar reasons to the first example.

Furthermore, in the second example, the blank period is provided between the modulated signals only during a period in which a scanning wiring near the boundary is selected, and therefore a total required blank period can be shortened in comparison with the first example. As a result, the driving time loss can be reduced greatly in comparison with the first example, thereby suppressing a reduction in the maximum luminance.

Note that the blank period may take a fixed value or may be varied in each position according to a distance from the boundary (an attenuation amount of the propagating noise) , as shown in FIG. 13B. More specifically, the blank period may be made steadily shorter as the distance from the boundary increases.

In the example shown in FIG. 8B, the predetermined range encompasses the M−2th row wiring to the M+3th row wiring, but the predetermined range is not limited thereto and as long as the predetermined range does not encompass the entire region of the upper side region and the lower side region, the above effects are obtained.

Note that FIG. 8B shows an example of the pulse amplitude modulation system, but the second example may also be applied to the pulse width modulation system or a system in which both the pulse width and the pulse height are modulated.

### Third Example

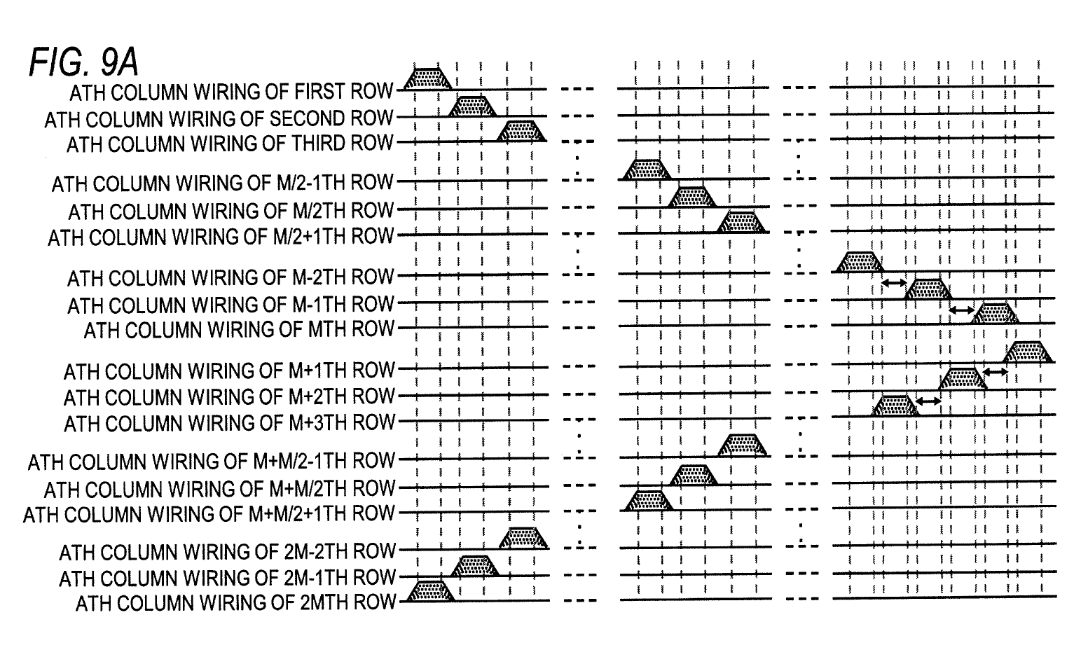

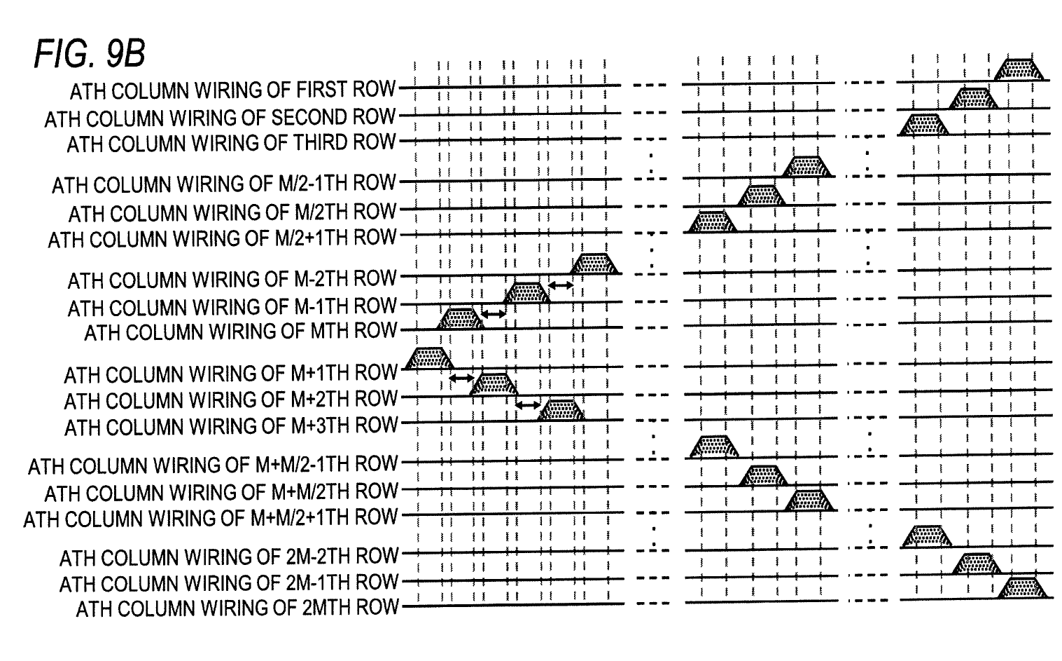

In a third example, the scanning circuit 14 scans the scanning wirings of the upper side region in an opposite direction to the scanning wirings of the lower side region. More specifically, as shown in FIG. 9A, scanning is performed from top to bottom in the upper side region and from bottom to top in the lower side region. Alternatively, as shown in FIG. 9B, scanning is performed from bottom to top in the upper side region and from top to bottom in the lower side region. All other constitutions are similar to the second example.

Hence, a reduction in display quality can be suppressed in the third example for the same reasons as the second example.

Furthermore, in the second example, as shown in FIG. 8B, the scanning direction of the scanning wirings in the upper side region is identical to the scanning direction of the scanning wirings in the lower side region, and therefore the selection timings of the scanning wirings near the boundary differ greatly between the upper side region and the lower side region. Hence, as shown in FIG. 13B, the blank period is required at both a start time and an end time of the scanning.

In the third example, on the other hand, the scanning wirings of the upper side region are scanned in an opposite direction to the scanning wirings of the lower side region, and therefore the selection timings of the scanning wirings near the boundary in the upper side region and the lower side region can be brought closer together (or made equal). Hence, when scanning is performed as shown in FIG. 9A, the blank period is provided only at the end time of the scanning, as shown in FIG. 13C, and when scanning is performed as shown in FIG. 9B, the blank period is provided only at the start time of the scanning, as shown in FIG. 13D. Accordingly, the total blank period can be shortened (halved) in comparison with the second example.

Note that FIGS. 9A and 9B show an example of the pulse amplitude modulation system, but the third example may also be applied to the pulse width modulation system or a system in which both the pulse width and the pulse height are modulated.

### Fourth Example

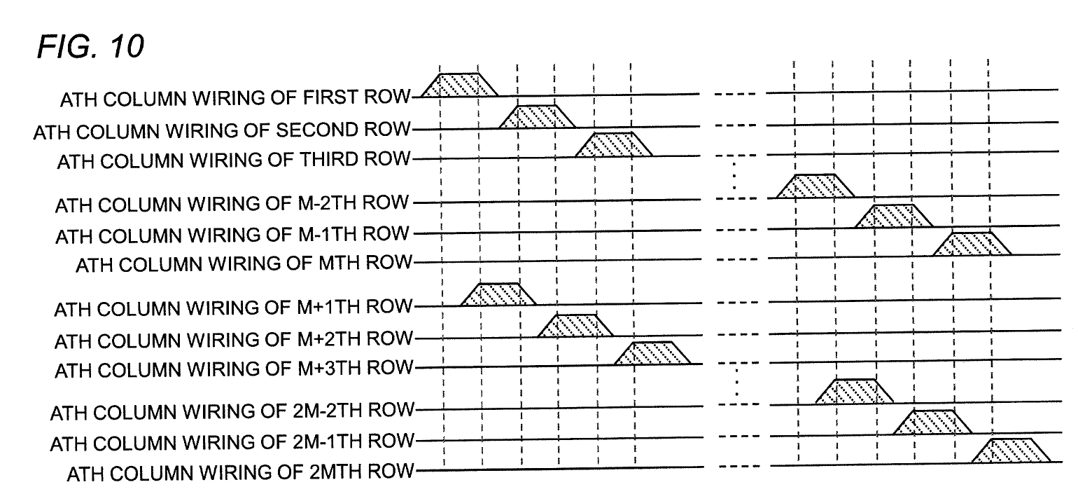

In a fourth example, the upper side modulated signal and lower side modulated signal are pulse signals subjected to pulse width modulation or modulation of both the pulse width and the pulse height. Further, as shown in FIGS. 10 and 12C, the upper side modulation circuit 13 and lower side modulation circuit 18 apply the modulated signals at timings ensuring that the upper side modulated signal rises at a different time to the lower side modulated signal. Note that in the fourth example, the row wiring selection timings differ between the upper side region and the lower side region.

When the pulse width of the modulated signal is modulated, the SN ratio decreases steadily as the pulse width decreases. In other words, the effect of the propagating noise strengthens steadily as the pulse width decreases.

In the fourth example, the rise of one modulated signal and the rise of another modulated signal differ from each other temporally, and therefore temporal overlap between modulated signals having small pulse widths does not occur. For example, temporal overlap is eliminated between periods A6, A7 and a period A5 in FIG. 12C. Hence, when the pulse widths of the modulated signals of the noise generation source and the noise reception source are both small, the timing at which noise is generated in the modulated signal of the noise generation source deviates from the application period of the modulated signal of the noise reception source, and as a result, a reduction in display quality caused by propagating noise can be suppressed.

When the pulse width of the modulated signal of the noise generation source is large (when bright display is performed), noise is generated during the application period of the modulated signal of the noise reception source, and the generated noise propagates. However, noise is generated when an image (a noise generation source image) having a great row direction length is displayed, and therefore a display surface area of the noise generation source image is large. In other words, noise that affects (propagates to) the modulated signal of the noise reception source occurs when bright display is performed over a wide range.

Here, when the pulse width of the modulated signal of the noise reception source is small (when dark display is performed), a bright object and a dark object are displayed. Accordingly, a display spot caused by the propagating noise appears on the dark object. However, according to the characteristics of the human eye, a visibility of the dark object decreases greatly when a bright object and a dark object are displayed, and therefore the display spot is substantially invisible.

When the pulse width of the modulated signal of the noise reception source is large, the signal level is also large, leading to an increase in the SN ratio, and therefore the reduction in display quality is extremely small.

Hence, in the fourth example, a reduction in display quality caused by noise propagation can be suppressed regardless of the pulse width of the modulated signal of the noise reception source.

Further, in the fourth example, a modulated signal having a large pulse width and a modulated signal having a small pulse width may overlap, and therefore, as shown in FIGS. 10 and 12C, a constitution in which a blank period is not required at a maximum pulse width can be provided. As a result, a reduction in display quality can be suppressed without causing a reduction in the maximum luminance. Note that a blank period may be provided at the maximum pulse width, and with this constitution, a reduction in display quality can be suppressed even further.

FIGS. 10 and 12C show an example in which the rise of one modulated signal and the rise of another modulated signal deviate by substantially half the time of a single horizontal scanning period, but the deviation between the rise of one modulated signal and the rise of the other modulated signal is not limited thereto and may be longer or shorter than substantially half the time of a single horizontal scanning period. As long as even a slight deviation exists, the above effects are obtained.

FIGS. 10 and 12C show an example in which the upper side modulated signal and the lower side modulated signal are pulse signals in which both the pulse width and the pulse height are modulated, but the modulated signals may be pulse signals in which only the pulse width is modulated, and the above effects are obtained in this case also.

### Fifth Example

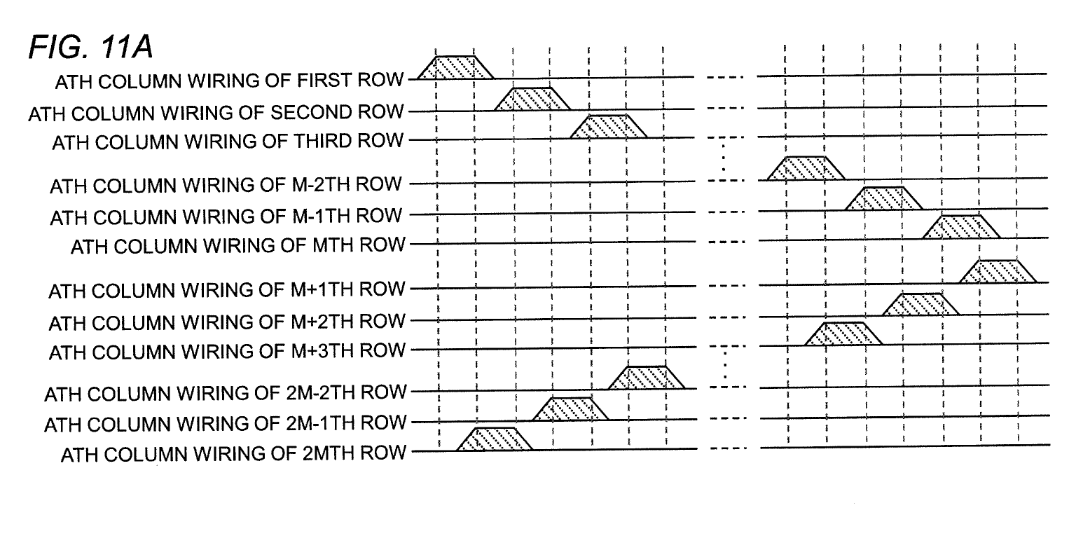

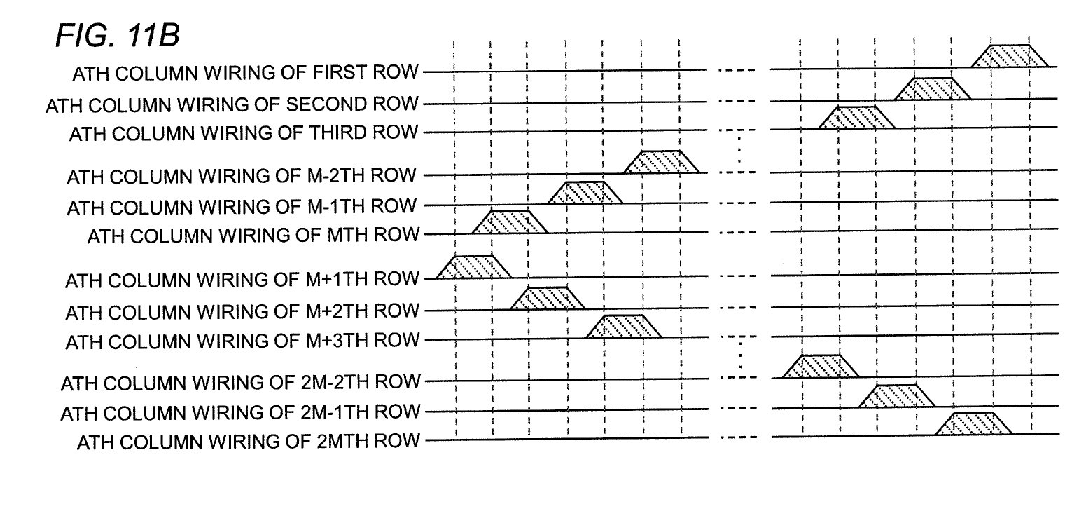

In a fifth example, the scanning circuit 14 scans the scanning wirings of the upper side region in an opposite direction to the scanning wirings of the lower side region. More specifically, as shown in FIG. 11A, scanning is performed from top to bottom in the upper side region and from bottom to top in the lower side region. Alternatively, as shown in FIG. 11B, scanning is performed from bottom to top in the upper side region and from top to bottom in the lower side region. All other constitutions are similar to the fourth example.

Hence, in the fifth example, a reduction in display quality can be suppressed without causing a reduction in the maximum luminance for the same reasons as the fourth example.

Further, in the fifth example, when the pulse width of the modulated signal of the noise generation source is large, the noise generation source image and the display spot are invariably positioned close together (positioned near the inter-region boundary), as shown in FIG. 3G. According to the characteristics of the human eye, the visibility of a dark object decreases steadily as the distance between the dark object and a bright object decreases. Therefore, when the pulse width of the modulated signal of the noise reception source is small, the visibility of the display spot is reduced below that of the fourth example, and as a result, a reduction in display quality can be suppressed even further.

As described above, with the constitutions of the first to fifth examples, a reduction in image quality occurring when an image display apparatus is driven using a dual scanning system can be reduced through a simple constitution whereby application timings of modulated signals are adjusted. Adjustment of the application timings of the modulated signals can be performed (realized at low cost) using a simple delay circuit or timing control circuit, for example.

Note that in the first to fifth examples, the upper side modulated signal and lower side modulated signal are preferably pulse signals in which either the pulse width or both the pulse width and the pulse height have been modulated, and are signals that have been subjected to pulse width correction in order to correct variation in the display characteristics of the display elements.

By employing this constitution, the timings at which noise is generated in the modulated signal of the noise generation source are dispersed, leading to a reduction in a probability of timing overlap with the steady part of the modulated signal of the noise reception source. As a result, a probability of display spot generation can be reduced (an amount of generated display spots can be reduced).

Note that in the first to fifth examples, the scanning wirings are set as the row wirings and the modulation wirings are set as the column wirings, but the scanning wirings may be set as the column wirings and the modulation wirings may be set as the row wirings.

In this embodiment, the display panel is divided into two regions, namely the upper side region and the lower side region, but any number of regions may be provided (four or nine, for example) as long as at least two regions arranged in the scanning direction are included.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-001059, filed on Jan. 6, 2010, which is hereby incorporated by reference herein in its entirety.

What is claimed is:

1. An image display apparatus comprising:
a display panel which has at least a first region and a second region arranged in a scanning direction, and on which a plurality of scanning wirings and a plurality of modulation wirings disposed in a matrix shape and a plurality of display elements connected to the plurality of scanning wirings and the plurality of modulation wirings are provided respectively in the first region and the second region;
a scanning circuit that is provided in common to the first region and the second region and scans the scanning wirings in each of the regions such that at least a part of a period for scanning the scanning wirings in the first region overlaps at least a part of a period for scanning the scanning wirings in the second region;
a first modulation circuit provided for the first region to apply a modulated signal to the plurality of modulation wirings in the first region; and
a second modulation circuit provided for the second region to apply a modulated signal to the plurality of modulation wirings in the second region,
wherein the modulated signal applied by the first modulation circuit and the modulated signal applied by the second modulation circuit are pulse signals having a varying pulse height part and a fixed pulse height part, and
the first modulation circuit and the second modulation circuit apply the modulated signals at timings ensuring that the fixed pulse height part of the modulated signal applied by the first modulation circuit does not temporally overlap the fixed pulse height part of the modulated signal applied by the second modulation circuit.

2. The image display apparatus according to claim 1, wherein the first modulation circuit and the second modulation circuit apply the modulated signals at timings ensuring that the fixed pulse height part of the modulated signal applied by the first modulation circuit does not temporally overlap the fixed pulse height part of the modulated signal applied by the second modulation circuit, only during a period in which a scanning wiring positioned within a predetermined range from a boundary between the first region and the second region has been selected by the scanning circuit.

3. An image display apparatus comprising:
a display panel which has at least a first region and a second region arranged in a scanning direction, and on which a plurality of scanning wirings and a plurality of modulation wirings disposed in a matrix shape and a plurality of display elements connected to the plurality of scanning wirings and the plurality of modulation wirings are provided respectively in the first region and the second region;
a scanning circuit that is provided in common to the first region and the second region and scans the scanning wirings in each of the regions such that at least a part of a period for scanning the scanning wirings in the first region overlaps at least a part of a period for scanning the scanning wirings in the second region;
a first modulation circuit provided for the first region to apply a modulated signal to the plurality of modulation wirings in the first region; and
a second modulation circuit provided for the second region to apply a modulated signal to the plurality of modulation wirings in the second region,
wherein the modulated signal applied by the first modulation circuit and the modulated signal applied by the second modulation circuit are pulse signals in which either a pulse width or both the pulse width and a pulse height have been modulated, and
the first modulation circuit and the second modulation circuit apply the modulated signals at timings ensuring that the modulated signal applied by the first modulation circuit and the modulated signal applied by the second modulation circuit rise at different times.

4. The image display apparatus according to claim 3, wherein the scanning circuit scans the scanning wirings of the first region in an opposite direction to the scanning wirings of the second region.

5. The image display apparatus according to claim 3, wherein the modulated signal applied by the first modulation circuit and the modulated signal applied by the second modulation circuit are pulse signals in which either the pulse width or both the pulse width and the pulse height have been modulated, and are signals that have been subjected to pulse width correction in order to correct variation in a display characteristic of the display elements.

6. A control method for an image display apparatus including: a display panel which has at least a first region and a second region arranged in a scanning direction, and on which a plurality of scanning wirings and a plurality of modulation wirings disposed in a matrix shape and a plurality of display elements connected to the plurality of scanning wirings and the plurality of modulation wirings are provided respectively in the first region and the second region; a scanning circuit provided in common to the first region and the second region; a first modulation circuit provided for the first region to apply a modulated signal to the plurality of modulation wirings in the first region;
and a second modulation circuit provided for the second region to apply a modulated signal to the plurality of modulation wirings in the second region, the control method comprising:
a scanning step in which the scanning circuit scans the scanning wirings in each of the regions such that at least a part of a period for scanning the scanning wirings in the first region overlaps at least a part of a period for scanning the scanning wirings in the second region; and
an application step in which the first modulation circuit and the second modulation circuit apply modulated signals to the plurality of modulation wirings in the corresponding regions, respectively,
wherein the modulated signal applied by the first modulation circuit and the modulated signal applied by the second modulation circuit are pulse signals having a varying pulse height part and a fixed pulse height part, and
in the application step, the first modulation circuit and the second modulation circuit apply the modulated signals at timings ensuring that the fixed pulse height part of the modulated signal applied by the first modulation circuit does not temporally overlap the fixed pulse height part of the modulated signal applied by the second modulation circuit.
